(19) United States
(12) Patent Application Publication
(10) Pub. No.: US 2019/0246653 A1
(43) Pub. Date: Aug. 15, 2019

(54) Methods of Making Vegetarian Snack Food Products

(71) Applicant: Frito-Lay North America, Inc., Plano, TX (US)

(72) Inventors: Charlene Gladden, McKinney, TX (US); Chien-Seng Hwang, Frisco, TX (US); Thomas Anthony Trezza, Plano, TX (US); Chad Woelfle, Farmers Branch, TX (US); Yi Zhu, Plano, TX (US)

(21) Appl. No.: 15/895,088

(22) Filed: Feb. 13, 2018

(51) Int. Cl. A21D 13/45; A21D 2/26; A21D 2/36; A21D 13/064; A21D 13/24

(52) U.S. Cl. CPC A21D 13/45; A21D 2/265; A21D 13/24; A21D 2/36; A21D 13/064; A21D 2/266

(57) ABSTRACT

Gluten and a plant protein are combined with an aqueous solution to make a dough useful for making either an expanded wafer or a leather snack food product. When compressed between two heated surfaces, the dough flattens while releasing moisture to produce an expanded wafer. The expanded wafers may be cut into shapes and/or topped with various snack food toppings to make either sweet or savory snack food products. The wafers may also be used to make a sandwich-type snack food using at least two wafers with a filling in between. Alternatively, the expanded wafer be infused with flavoring solutions to form leather snack food products.

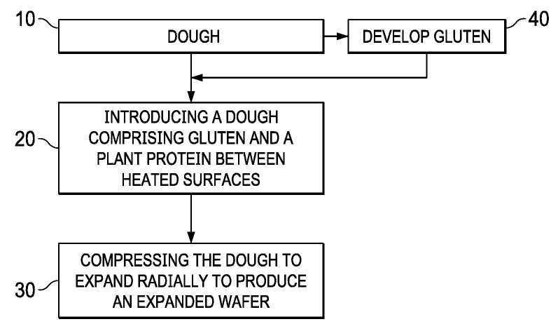

### BACKGROUND OF THE INVENTION

### Technical Field

The present invention relates to a method of making a vegetarian snack food product from a dough comprising wheat gluten.

### Description of Related Art

Food products comprising vital wheat gluten flour often do not contain a desirable texture for some. Some snack food products containing vital wheat flour also contain high amounts of refined sugar such as sucrose or natural sweeteners to produce more desirable textures. However, such products typically have low protein quality and high amounts of added carbohydrates and sugars. There remains a need for alternative high protein snack food products that satisfy textures and tastes.

### SUMMARY OF THE INVENTION

There is a need for more versatile methods of preparing snack bases comprising quality proteins that can be flavored as either savory or sweet. Below is a simplified summary of this disclosure meant to provide a basic understanding of the method and product described herein. This is not an exhaustive overview and is not intended to identify key or critical elements or to delineate the scope of the description. Its sole purpose is to present some concepts in a simplified form as a prelude to the more detailed description below.

The present disclosure is directed to a versatile method for preparing vegetarian snack food products from a dough having high quality protein and low amounts of sugar, which can be cooked into light wafers or into leathery snack food products.

In one embodiment, the method comprises the steps of introducing a dough between two heated surfaces, the dough comprising wheat gluten and at least one additional plant protein; and compressing the dough between the heated surfaces until producing an expanded wafer. The expanded wafer can be used to create a variety of snack food products. In some embodiments, the expanded wafer is further processed to make a shelf-stable wafer and/or a shaped wafer. In some embodiments, the method further comprises the steps of infusing the expanded wafers with a flavoring solution to create an infused wafer and dehydrating the infused wafer to a moisture content of less than about 30% to form a leather snack food products.

Other aspects, embodiments, and features of this disclosure will become apparent in the following written description and accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein the:

FIGURE depicts a flow chart showing one embodiment of the method disclosed herein.

### DETAILED DESCRIPTION

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The terms “including,” “comprising,” “having,” and variations thereof mean “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount (i.e, 0%) is added in some embodiments. The invention illustratively disclosed herein suitably may be practiced in the absence of any element that is not specifically disclosed herein.

Unlike the presently described wafers, currently known wafers are typically high in refined sugar in the base and made using a batter that is poured onto a wafer plate. The dough described herein, as well as the product resulting from the method of using the dough, comprises low (less than about 15%) amounts of added sugar, while comprising a good amount of protein. In some embodiments, both the dough and the final product each comprise less than about 5% added sugar.

The present method makes use of flat plate compression to cook the dough described herein to a desirable shelf-stable snack food product comprising a high amount of high quality protein. In some embodiments, the dough may comprise between about 15 to about 25 grams of protein on a dry basis for 1-oz serving sizes. In some embodiments, the dough comprises between about 18 to about 22 grams of protein on a dry basis for 1-oz serving sizes.

With reference to the FIGURE, in one embodiment, the method comprises the steps of forming or obtaining a dough 10 comprising wheat gluten and a plant protein; introducing the dough comprising the concentrated gluten between two heated surfaces 20; and compressing the dough between the heated surfaces until producing an expanded wafer 30. Optionally, the gluten may be developed 40 prior to the introducing between heated surfaces 20. In some embodiments, the forming step 10 comprises the combining of dry ingredients together with an aqueous solution as further described below.

The dough 10 described herein comprises at least about 5% wheat gluten. In one embodiment, the dough comprises at least 50% wheat gluten. In some embodiments, the dough comprises between about 50% to about 73% wheat gluten. In some embodiments, the dough comprises between about 55% to about 67% wheat gluten. In some embodiments, the dough comprises between about 60% to about 65% wheat gluten. Unless otherwise stated, all components of the dough are expressed in accordance with their percentage based on a dry basis.

As used herein, wheat gluten is used interchangeably with the term gluten and refers to protein made by washing wheat flour with water until almost all starches are dissolved and gluten remains. Gluten is known to include protein (including gliadins and glutenins) in an amount of between about 50% to about 90% by weight, less than about 20% starch, and about 5% to about 7% fat. While gluten is typically found in and isolated from wheat in what is classified as a wheat protein concentrate, in some embodiments, suitable gluten may be isolated from wheat, barley, rye, oats, and related species and/or hybrids of wheat, barley, rye, oats, and any combination thereof. Suitable gluten should mimic the gluten protein found in wheat. In some embodiments, the gluten or wheat gluten comprises less than about 10% starch. In some embodiments, the wheat gluten comprises between about 60% to about 90% protein. In some embodiments, the wheat gluten comprises vital wheat gluten. In some embodiments, the wheat gluten consists of vital wheat gluten. In some embodiments, the wheat gluten comprises about 60% to about 80% protein. In some embodiments, the wheat gluten comprises about 75% to about 80% protein. While gluten is currently commercially available in the form of powder, wheat gluten suitable for preparation of the dough may be in any dry form known in the art including without limitation flour, granules, flakes, clusters, powder, or any combination of such dry forms, for example. Gluten sources may be obtained from any number of manufacturers or sources.

In addition to the wheat gluten, the dough also comprises a plant protein. That is, the dough comprises a wheat gluten and an additional plant protein. Suitable plant proteins include, for example, dry forms (i.e. <14% moisture content) of plant proteins derived, isolated, extracted, or concentrated from legumes such as peas, beans, chickpeas, lentils, lupin beans, and any combination thereof. Suitable dry forms include without limitation flour, course meal, granules, flakes, clusters, powder, or any combination of such dry forms. For example, flour or milled dry forms of a plant protein is incorporated with the gluten when preparing the dough. In some embodiments, the dough comprises between about 10% to about 45% plant protein, on a wet basis. In some embodiments, the dough comprises between about 15% to about 35% plant protein, on a wet basis. In some embodiments, the dough comprises between about 18% to about 25% plant protein, on a wet basis. Suitable forms of dry components of plant proteins as described herein are readily available on the market.

In some embodiments, the plant protein comprises a single legume protein. In some embodiments, the plant protein consists of a single legume protein. In some embodiments, the plant protein comprises more than one legume protein. The legume protein may consist of one or more legume proteins in some embodiments. In some embodiments, the legume comprises a pea protein. In some embodiments, the legume comprises a bean protein. In some embodiments, the legume comprises a chickpea protein. In some embodiments, the legume comprises a lentil protein. In some embodiments, the legume comprises a lupin bean protein. In some embodiments, the plant protein comprises pea protein, bean protein, chickpea protein, lentil protein, lupin bean protein, and any combination thereof. Any form of such proteins may be used, including without limitation, for example, flour, powder, agglomerates, or flakes.

In some embodiments, the dough comprises between about 10% to about 40% pea protein, on a dry basis. In some embodiments, the dough comprises between about 15% to about 28% pea protein, on a dry basis. In some embodiments, the dough comprises between about 18% to about 25% pea protein, on a dry basis. In some embodiments, the dough comprises up to about 20% chickpea protein, on a dry basis. In some embodiments, the dough comprises between about 5% to about 15% chickpea protein, on a dry basis. In some embodiments, the dough comprises between about 8% to about 12% chickpea protein, on a dry basis.

In certain embodiments, the plant protein comprises a first legume protein and a second legume protein. In certain embodiments, the plant protein comprises a legume protein comprising of a combination of pea protein and chickpea protein. In certain embodiments, the plant protein comprises a legume protein consisting of a combination of pea protein and chickpea protein. In such embodiments, a dry component portion of the dough comprises between about 10% to about 30% pea protein and up to about 20% chickpea protein. In some embodiments, the dry component portion of the dough comprises between about 15% to about 28% pea protein and between about 5% to about 15% chickpea protein. In some embodiments, the dry basis formulation comprises between about 18% to about 25% pea protein and between about 8% to about 12% chickpea protein flour.

In addition to the plant proteins described above, the dough may also comprise a cereal grain in some embodiments. A suitable cereal grain should comprise a dry component such as flours, flakes, agglomerates, granules, or powders derived from a cereal or grain. The cereal grain may be derived from, for example, oats, barley, rice, corn, sorghum, soy, or a combination thereof. In some embodiments, the dough comprises a protein extract of cereals, usually called concentrated or isolated proteins. In one embodiment, the dough comprises a dry component derived from a cereal grain. The dough may comprise, for example, up to about 10% barley in some embodiments. In certain embodiments, the dough may comprise between about 2% to about 8% barley. In certain embodiments, the dough may comprise between about 4% to about 7% barley.

In some embodiments, the dough and the final product are both free of seeds, whole kernels, and whole pulses. In other embodiments, if more protein is desired, whole seeds or kernels may be added to either the dough or the final product.

Additionally, in some embodiments, additional seasoning may be added in minor amounts of no more than about 4%. Any number of seasoning particles or elements may be added in such minor amounts. By way of example without intending to limit the scope of this disclosure, the additional seasoning may comprise sodium chloride, table salt, kosher salt, sea salt, pepper, paprika, dill, cinnamon, sugar, cardamom, ginger, mustard, parsley, sage, thyme, and any combination thereof. In some embodiments, the dry portion of the dough comprises up to about 4% table salt (i.e., sodium chloride). In some embodiments, the dry portion of the dough comprises up to about 3% salt. In some embodiments, the dry portion of the dough comprises between about 1% to about 2.5% salt.

Once the dry components of the dough are combined, an aqueous solution may be used to form the dough 10. In some embodiments, the aqueous solution comprises water. In some embodiments, the aqueous solution comprises between about 60% to about 99% water. In some embodiments, the aqueous solution consists of water. In some embodiments, the amount of dry components used should slightly exceed (i.e., by up to 10%) the amount of aqueous solution. The dough should comprise a moisture content of between about 35% to about 65%. In some embodiments, the dough comprises a moisture content of between about 40% to about 60%. In some embodiments, the dough comprises a moisture content of between about 45% to about 55%. During test runs, between about 80% to about 95% aqueous solution was added to the dry component portion of the dough to arrive at a dough.

Referring back to the FIGURE, the dough comprising gluten and a plant protein is introduced between heated surfaces 10. In some embodiments, the heated surfaces comprise at least two heated surfaces; that is, at least two hot surfaces heated prior to the introducing step 10. The heated surfaces are unbattered and free of oil. In some embodiments, the heated surfaces comprise two meeting parallel surfaces that have been heated prior to introducing step 10. In some embodiments, the heated surfaces comprise substantially flat parallel surfaces. In some embodiments, the heated surfaces comprise at least a portion of a nearly flat or planar face for meeting the dough. Generally, the surfaces should comprise a temperature sufficiently high to produce steam when flattening the dough in the next step 20, discussed further below. For example, during successful test runs, dough was introduced between two substantially flat plates comprising temperatures of between about 250° F. to about 400° F. In some embodiments, the heated surfaces comprise two parallel flat plates. In some embodiments, the heated surfaces comprise counter-rotating parallel rolls directly across from one another through which the dough may be flattened. In some embodiments, the heated surface comprises a temperature ranging from about 250° F. to about 400° F. In some embodiments, the heat applied to the dough may range from about 275° F. to about 375° F. In some embodiments, the heated surface comprises a temperature ranging from about 290° F. to about 325° F. In some embodiments, the heated surface comprises a temperature of about 300° F.

In some embodiments, the dough described herein is rounded prior to the introducing step; that is, the method may comprise a step of rounding the dough into a ball prior to introducing between the heated surfaces. In some embodiments, the dough may be rounded into a plurality of individual dough portions. Depending on the desired shape or size, the dough may be cut or otherwise shaped into the desired size prior to the introducing between heated surfaces. In some embodiments, prior to the introducing step 10, striations are formed in the dough by pulling or stretching the dough in a single direction one or more times, thereby forming elongated aligned protein strands in the dough. As used herein, striations refer to the visible layering effect or muscle-like fibers formed by the gluten. In some embodiments, prior to the introducing step 10, the method comprises a step of forming a striated dough. In such forming step, for example, the dough is pulled or stretched until striations are formed within a striated dough comprising a substantially consistent or uniformly consistent dough of a thickness of less than about 5 cm. Thus, in some embodiments, the dough comprises a striated dough introduced between the heated surfaces. In certain embodiments, the method further comprises introducing a cut, striated dough between heated surfaces. In some of said embodiments, the method comprises forming striations in the dough followed by a cutting step to cut the formed striated dough into smaller portions, more akin to snack sizes. Striated dough comprises a structure of parallel layers, comprising muscle-like striations in some embodiments. In some embodiments, a cutting step may follow the introducing step, which will be further described below.

In some embodiments, prior to the introducing step 10, the method may comprise a step of resting the dough for a period of time to develop the gluten-based dough into a structure that allows for elasticity and strength to the dough. Developing the gluten refers to the resting the dough for a period of time and optionally cooking the dough to develop the gluten. In some embodiments, this optional cooking step to develop the gluten comprises microwaving, frying, boiling, broiling, steaming, or any combination thereof. Any other method of cooking commonly known in the art may also be used to develop the gluten. In certain embodiments, the method comprises a step of microwaving the dough comprising the gluten and the plant protein. In certain embodiments, the method comprises a step of frying the dough comprising the gluten and the plant protein. In certain embodiments, the method comprises a step of boiling the dough comprising the gluten and the plant protein. In certain embodiments, the method comprises a step of broiling the dough comprising the gluten and the plant protein. In certain embodiments, the method comprises a step of steaming the dough comprising the gluten and the plant protein.

Returning to the steps of the FIGURE, after introducing the dough between heated surfaces 10, the method comprises the step of compressing the dough to produce an expanded wafer 20. Compressing between the heated surfaces forces the dough to expand radially, as opposed to vertically, causing the release of moisture from the dough in the form of steam and causing the expanding of the dough into a flattened wafer of a generally consistent thickness. In some embodiments, the dough may be pressed between two heated surfaces until an expanded wafer of less than about 5 cm is produced. Compressing is performed free of any vacuum or vacuum chamber.

Compressing times will depend upon the temperature of the heated surfaces. Higher temperatures may allow for shorter compressing times. Lower ends of the temperature ranges provided herein may necessitate further cooking of the wafer between the heated surface without compressing or pressing. The compressing step 20 may be performed for up to 60 seconds in some embodiments. The compressing step 20 may be performed for up to 30 seconds in some embodiments. The compressing step 20 may be performed for up to 15 seconds in some embodiments.

In some embodiments, after compressing to produce the expanded wafer 20, the method may comprise an optional step of cutting the wafer into desirable shapes and/or sizes. Following formation of the expanded wafer 20, the method comprises the step of cutting the expanded wafer into a plurality of shapes, in some embodiments. Cutting refers to the reduction of the size of the expanded wafer by any means known in the art. One skilled in the art can determine a plethora of desirable shapes and/or cutting steps. For example, the expanded wafer may be cut into any number of basic shapes, such as circles or squares, as well as more complex, decorative shapes, such as stars or holiday-themed shapes throughout the year.

In certain embodiments, after the compressing step, the method further comprises the step of dehydrating the expanded wafer to produce a shelf-stable wafer with a moisture content of less than about 4%. In some embodiments, the dehydrating step reduces the moisture content to between about 2% to about 4%. In some embodiments, the dehydrating step reduces the moisture content to between about 3% to about 4%. In some embodiments, the dehydrating step comprises cooking the expanded wafer between the heated surfaces in the absence of compressing the surfaces together. In certain embodiments, the dehydrating step comprises heating the expanded wafer at temperatures of between about 150° F. to about 300° F. In some embodiments, dehydrating comprises heating the expanded wafer at temperatures of between about 175° F. to about 275° F. In certain embodiments, dehydrating comprises heating the expanded wafer at temperatures of between about 200° F. to about 250° F. By way of example, during batch test runs, heat and pressure were simultaneously applied using a tortilla press for up to one minute, following by continued cooking between the flat plates of the tortilla press without pressing, and while maintaining the temperature of the tortilla press, for up to one minute. The method may further comprise the step of cooling the expanded wafer to a temperature of about 75° F. prior to the dehydrating step.

In some embodiments, the resulting expanded wafer comprises a density of about 0.001 to about 1 g/cm³. In some embodiments, the resulting expanded wafer comprises a density of about 0.005 to about 0.75 g/cm³. In some embodiments, the resulting expanded wafer comprises a density of about 0.01 to about 0.5 g/cm³. The expanded wafer generally comprises a low tooth pack, which refers to little to no food residue left impacted between teeth. This contrasts with typical high sugar wafers, which are also high in starch. Amylose starch hydrates and sticks to the tongue, leaching moisture from the mouth. However, the wafers described herein provide for a cleaner, more desirable eating experience. In addition, the resulting expanded wafer comprise a pearlescent sheen or satin surface, which also contrasts with high sugar wafers.

In some embodiments, the method may comprise adding a topping to the surface of the expanded wafer to create a topped wafer. In some embodiments, the topping may comprise solid particles such as seasonings, shredded food, food bits, or other edible particles that provide good flavor and desirable texture. In some embodiments, the topping may comprise a viscous component such as one having a creamy consistency. Without intending to limit the scope of such toppings, suitable toppings may include nut butters (for example, peanut butter, sunbutter, almond butter, etc.), small solids, such as shredded coconut, sprinkles, dried fruit bits, nuts, dried vegetable bits, etc., either alone or in addition to the viscous component.

In some embodiments, the method may comprise a step of forming a nut butter based topping (i.e., comprising a majority portion nut butter) and/or a step of pressing the filling between the heated surface to form a flattened topping suitable to adhere to a surface of the base wafer. In some embodiments, a topped wafer may comprise about 10 to about 90% topping, by weight of the topped wafer product. In some embodiments, a topped wafer may comprise about 50 to about 75% topping. In some embodiments, a topped wafer may comprise about 70% topping.

In some embodiments, following application of a viscous topping to a first expanded wafer, the method may comprise the step of adding a second expanded wafer to the topping to produce a wafer-sandwich snack food such that the topping becomes a filling between the first expanded wafer and the second expanded wafer. In some embodiments, a nut-based filling is prepared by pressing the filling components between the heated surface to produce a flattened, hardened filling that can be adhered in between two base wafers. Appealing snack-sized, sandwich like snack food products can be produced in this way. In some embodiments, snack-sized wafer sandwiches comprise a ratio of approximately 25% base wafer to about 75% filling.

In an additional embodiment, the method also comprises the step of infusing the expanded wafer with a flavoring solution to create an infused wafer; that is, a wafer infused with flavor. Once infused with the flavoring solution, the infused wafer is dehydrated to a moisture content of less than about 30% to form a leather food snack. In some embodiments, the infusing step comprises vacuum-sealing the expanded wafer and the flavoring solution. In some embodiments, the expanded wafer and flavoring solution are vacuum-sealed overnight. In some embodiments, the flavoring solution may include various fruits and/or their juices, such as—by way of example and without intending to limit the scope of this disclosure—apple, mango, grape, orange, strawberry, lemon, blueberry, etc. Such fruit flavoring may be selected to create a high protein fruit leather food snack with an appealing and pleasing flavor. In some embodiments, the flavoring solution may alternately consist of a savory flavoring, such as teriyaki, Thai, red curry, etc, to produce a savory high-protein leather food snack. In some embodiments, the infused wafer comprises a ratio of wafer base to fruit coating of about 75% to about 25%.

The present invention is more particularly described in the following examples which are intended as illustrative only given that numerous modifications and variations therein will be apparent to those skilled in the art.

### Example 1: Plant Protein Wafer

Vital wheat gluten, pea protein, garbanzo bean flour, barley flour, and kosher salt were mixed in a stand mixer. About 92% water was streamed into the mixer. The resulting dough was kneaded for about five minutes. The dough was then rounded into portions of about 10 grams, and allowed to rest. The rounded balls were then manually flattened slightly and introduced between two heated (about 300° F.) plates of a tortilla press. The flattened balls were pressed for about one minute to form an expanded wafer, which was then cooked for about one minute at the same temperature within the same tortilla press without pressing. The resulting wafer was cut into shapes while still warm. The shaped wafers were dried at about 225° F. with a low fan for about five minutes.

### Example 2: Sunflower Butter Banana Bite

Wafers prepared via the method in Example 1 were cut into snack sized bites. Filling was created by kneading together a mixture comprising at least 50% sunflower seed butter, equal parts brown rice syrup and crumbled shaped wafers, less than about 10% ground, freeze-dried banana, and less than 2% flour salt. The filling was pressed on the tortilla press and cut into shapes corresponding with the shaped wafers. Sandwiches were assembled (shaped wafer-filling-shaped wafer) using brown rice syrup to adhere. Sandwiches were topped with melted and tempered dark chocolate and crushed sweetened banana chips. The completed bite had a ratio of approximately 30% shaped wafer, 60% filling, and 10% chocolate and banana topping.

### Example 3: Apple Mango Leather

Shaped wafer bases were prepared via the method in Example 1. About 160 grams apple juice concentrate was brought to boiling, and about 20 grams of ground, freeze-dried mango was whisked in. The shaped wafer bases were brushed with the resulting apple-mango concentrate to soften. The softened wafers were then infused with the remaining apple-mango concentrate in a vacuum bag overnight. The infused wafers were dried at about 155° F. for about two hours, flipping halfway.

Unless otherwise specified, all percentages, parts and ratios as used herein refer to percentage, part, or ratio by weight of the total. Unless specifically set forth herein, the terms “a”, “an”, and “the” are not limited to one of such elements, but instead mean “at least one,” unless otherwise specified. The term “about” as used herein refers to the precise values as indicated as well as to values that are within statistical variations or measuring inaccuracies.

The methods disclosed herein may be suitably practiced in the absence of any element, limitation, or step that is not specifically disclosed herein. Similarly, specific snack food embodiments described herein may be obtained in the absence of any component not specifically described herein. Thus, the snack food products described herein may consist of those listed components as described above.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, the range 1 to 10 also incorporates reference to all rational numbers within that range (i.e., 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

While this invention has been particularly shown and described with reference to a preferred embodiment, it will be understood by those skilled in the art that various changes, in form and detail may be made therein without departing from the spirit and scope of the invention.

We claim:

1. A method of making a vegetarian snack food product, the method comprising the steps of:
introducing a dough between two heated surfaces, the dough comprising wheat gluten and a plant protein; and
compressing the dough between the heated surfaces until producing an expanded wafer.

2. The method of claim 1 wherein the dough further comprises a cereal grain.

3. The method of claim 1 comprising the step of dehydrating the expanded wafer to produce a shelf-stable wafer with a moisture content of less than about 4%.

4. The method of claim 3 comprising a step of cooling the expanded wafer to a temperature of about 75° F. prior to the dehydrating step.

5. The method of claim 1 comprising the step of cutting the expanded wafer into a plurality of shapes.

6. The method of claim 1 wherein the dough comprises at least about 5% wheat gluten.

7. The method of claim 1, wherein the cereal grain comprises a dry component derived from legumes, beans, pulses, vegetables, oats, barley, rice, soy, or a combination thereof.

8. The method of claim 1, wherein the dough has a moisture content of about between about 35% to about 65%.

9. The method of claim 1 comprising a step of forming a striated dough.

10. The method of claim 1 wherein prior to the introducing step, the dough comprises a striated dough, and the method comprises a step of cutting the striated dough, thereby introducing a cut, striated dough between the two heated surfaces.

11. The method of claim 1 comprising a step of microwaving the dough prior to the introducing step.

12. The method of claim 1, wherein the heated surfaces comprise a temperature of about 250° F. to about 400° F.

13. The method of claim 1, wherein the expanded wafer comprises a density of about 0.001 to about 1.0 g/cm³.

14. The method of claim 1 further comprising the step of adding a topping to the surface of the expanded wafer.

15. The method of claim 14 comprising a step of adding an expanded wafer on the topping to form a sandwich-type snack food product.

16. The method of claim 1, further comprising the steps of:
infusing the expanded wafer with a flavoring solution to create an infused wafer comprising flavor; and
dehydrating the infused wafer to a moisture content of less than about 30% to form a leather food snack.

17. The method of claim 16 wherein the infusing step comprises vacuum-sealing the expanded wafer and the flavoring solution.
